(19) United States
(12) Patent Application Publication
(10) Pub. No.: US 2026/0239258 A1
(43) Pub. Date: Aug. 13, 2026

(54) METHOD AND SYSTEM FOR PERFORMING NETWORK REGISTRATION PROCESS IN WIRELESS NETWORK

(71) Applicant: SAMSUNG ELECTRONICS CO., LTD., Gyeonggi-do (KR)

(72) Inventors: Sivasankar Comaravelou, Bengaluru (IN); Prasad Basavaraj Dandra, Bengaluru (IN); Lalith Kumar, Bengaluru (IN); Mahmoud Watfa, Staines-Upon-Thames (GB)

(73) Assignee: SAMSUNG ELECTRONICS CO., LTD., Suwon-si (KR)

(21) Appl. No.: 19/150,794

(22) PCT Filed: Apr. 5, 2024
(86) PCT No.: PCT/KR2024/004465

§ 371 Date: Jul. 24, 2025

(30) Foreign Application Priority Data
Apr. 5, 2023 (IN) 202341025695
Apr. 4, 2024 (IN) 202341025695

(51) Int. Cl. H04W 60/00; H04W 84/04

(52) U.S. Cl. CPC H04W 60/001; H04W 60/002; H04W 84/042

(57) ABSTRACT

Provided is a method for performing a network registration process in a wireless network to access at least one network service, which includes: transmitting, by a user Equipment (UE), a network registration request to a network device of the wireless network to access one or more network slice services, wherein both the UE and the network device are associated with a same public land mobile network (PLMN); receiving, by the UE, a response message comprising one of a registration accept message and a registration reject message; and registering, based on the response message, by the UE, with one of the network device or another network device within the wireless network sharing the same PLMN to access the one or more network slice services.

### TECHNICAL FIELD

The disclosure relates to network registration for slices of services, and more specifically, to a method and a system for performing a network registration process in a wireless network to access at least one network service.

### BACKGROUND ART

A network registration process in a telecommunication system like a 5G system involves user equipment (UE) (e.g., smartphone or Internet of Things (IoT) device) registering with a network (e.g., Non-Terrestrial Networks (NTN), Terrestrial Networks (TN), etc.) to establish a connection and access services. This network registration process allows the network to authenticate the UE, assign one or more resources, and provide one or more network services. Examples of the one or more network services may include, but are not limited to, an Enhanced Mobile Broadband (eMBB) slice service, an Ultra-Reliable Low Latency Communication (URLLC) slice service, a Massive Machine Type Communication (MMTC) slice service, a Vehicle-to-everything (V2x) slice service, a High performance Machine Type Communication (HMTC) slice service.

### DISCLOSURE

### Technical Problem

The principal object of the embodiments herein is to disclose a methods for performing network registration in a wireless network to access at least one network service.

Another object of the embodiments herein is to disclose a User Equipment (UE) for performing network registration in a wireless network to access at least one network service.

### Technical Solution

This summary is provided to introduce a selection of concepts, in a simplified format, that are further described in the detailed description of the embodiments herein. This summary is neither intended to identify key or essential features of the disclosure nor is it intended for determining the scope of the disclosure.

According to one or more embodiments, there is provided a method for performing a network registration process in a wireless network to access at least one network service. The method may include: transmitting, by a user Equipment (UE), a network registration request to a network device of the wireless network to access one or more network slice services, wherein both the UE and the network device are associated with a same public land mobile network (PLMN); receiving, by the UE, a response message comprising one of a registration accept message and a registration reject message; and registering, based on the response message, by the UE, with one of the network device or another network device within the wireless network sharing the same PLMN to access the one or more network slice services.

According to one or more embodiments, there is provided a UE for performing the network registration process in the wireless network to access the at least one network service. The UE may include: a memory; a communicator; and a processor operably connected to the memory and the communicator. The processor may be configured to: transmit a network registration request to a network device of a wireless network to access one or more network slice services, wherein both the UE and the network device are associated with a same public land mobile network (PLMN); receive a response message comprising one of a registration accept message and a registration reject message; and register, based on the response message, by the UE, on one of the network device and another network device within the wireless network sharing the same PLMN to access the one or more network slice services.

According to one or more embodiments, there is provided a UE for performing the network registration process in the wireless network to access the at least one network service. The UE may include: a memory; a communicator; and a processor operably connected to the memory and the communicator. The processor may be configured to: transmit a network registration request to a network device of the wireless network to access one or more network slice services, wherein both the UE and the network device are associated with a same registration area comprising a plurality of tracking area identities (TAIs); receive a response message comprising one of a registration accept message and a registration reject message; and register, based on the response message, by the UE, with one of the network device and another network device within the wireless network sharing the same registration area to access the one or more network slice services.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### DESCRIPTION OF DRAWINGS

These and other features, aspects, and advantages of the present disclosure will become better understood when the following detailed description is read with reference to the accompanying drawings in which like characters represent like parts throughout the drawings, wherein:

FIGS. 1A and 1B illustrate one or more operations associated with a network registration process in existing telecommunication systems, according to one or more embodiments;

FIG. 2 is a sequence flow diagram illustrating a problem scenario associated with a network registration process for a Public Land Mobile Network (PLMN) in existing telecommunication systems, according to one or more embodiments;

FIG. 3 is a sequence flow diagram illustrating another problem scenario associated with a network registration process for a PLMN in existing telecommunication systems, according to one or more embodiments;

FIG. 4 is a sequence flow diagram illustrating a problem scenario associated with a network registration process for a Registration Area (RA) in existing telecommunication systems, according to one or more embodiments;

FIGS. 5A and 5B illustrate one or more operations associated with a network registration process in a wireless network, according to one or more embodiments;

FIG. 6 illustrates a block diagram of a User Equipment (UE) for performing the network registration process in the wireless network to access at least one network service, according to one or more embodiments;

FIGS. 7A-7C are sequence diagrams illustrating various operations associated with the network registration process and when a UE receives a registration accept message from a network device, according to one or more embodiments;

FIGS. 8A-8D are sequence diagrams illustrating various operations associated with the network registration process when a UE receives a registration reject message from the network device in the same PLMN, according to one or more embodiments;

FIGS. 9A, 9B, and 9C are sequence diagrams illustrating various operations associated with the network registration process when a UE receives a registration reject message from a network device in a same registration area (RA), according to one or more embodiments; and

FIG. 10 is a flow diagram illustrating a method for performing a network registration process in a wireless network to access a at least one network service, according to one or more embodiments.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### MODE FOR INVENTION

For the purpose of promoting an understanding of the disclosure, reference will now be made to embodiments illustrated in related drawings and specific language will be used to describe the same. It will nevertheless be understood that no limitation of the scope of the disclosure is thereby intended, such alterations and further modifications in the illustrated system, and such further applications of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in one embodiment”, “in another embodiment”, “in one or more embodiments” and similar language throughout this specification may, but do not necessarily, all refer to the same embodiment.

The terms “comprise”, “comprising” or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Furthermore, expressions such as “at least one of A and B” or “at least one of A or B”are to be understood as including only A, only B, or both A and B.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Herebelow, various embodiments of the disclosure are provided in reference to the drawings.

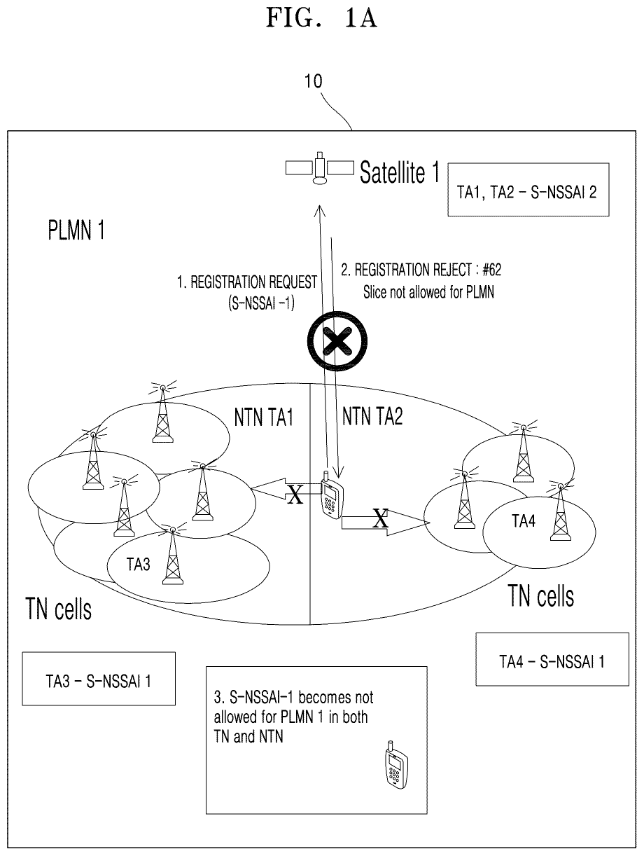

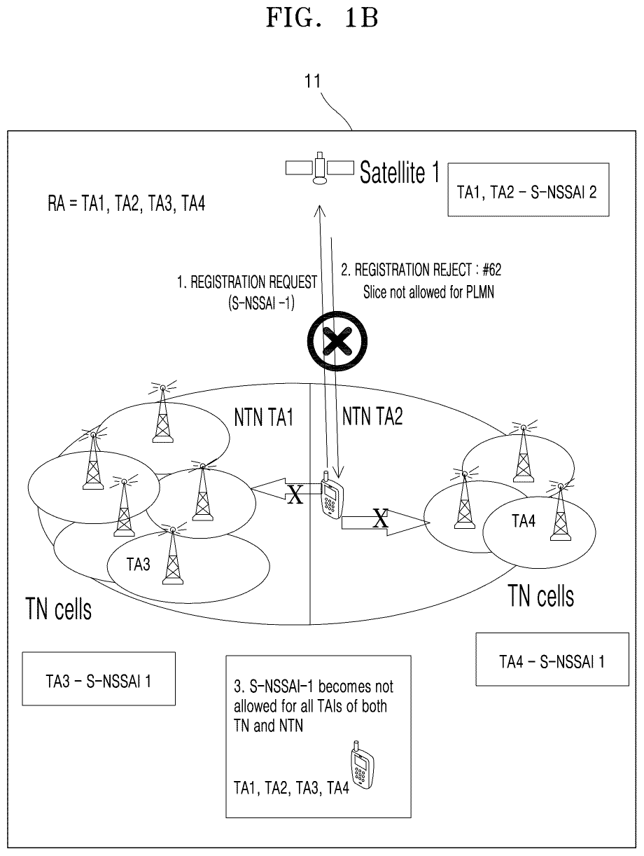

Existing telecommunication systems have explored both a Non-Terrestrial Network NTN and a Terrestrial Network (TN) to provide one or more network services to a UE with an aim of enhancing user experiences, as illustrated in FIGS. 1A and 1B. Nevertheless, inventors of the disclosure have identified problems encountered in the existing telecommunication systems as described in conjunction with FIGS. 1A-1B to 4.

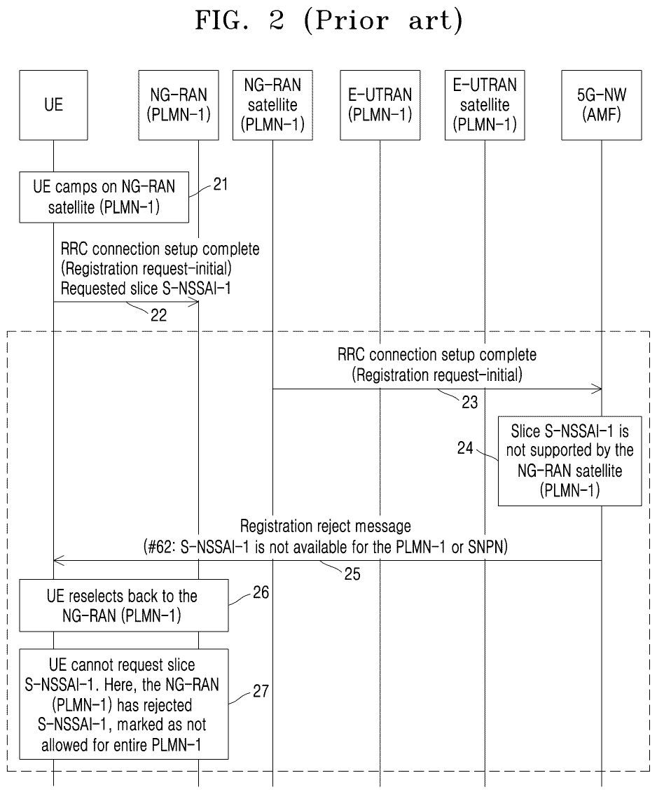

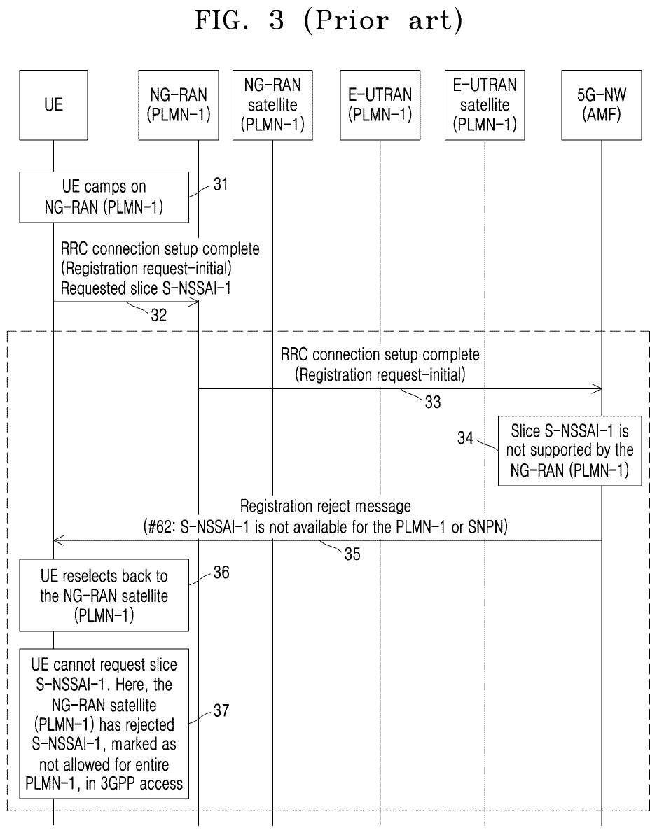

Consider a first scenario 10 illustrated in FIG. 1A, where a satellite-1 (e.g., Next Generation Radio Access Network (NG-RAN) satellite) belonging to a mobile or cellular network such as a Public Land Mobile Network (PLMN)-1 provides one or more network services to the UE within a sizable coverage area (depicted as a large elliptical circle). The satellite-1 encompasses two tracking areas, namely a Tracking Area Identity (TAI)-1 and a TAI-2, and supports a type-2 network service (e.g., Single Network Slice Selection Assistance Information (S-NSSAI)-2). Furthermore, one or more base stations (e.g., NG-RAN nodes) belonging to the PLMN-1 provide the one or more network services to the UE within a secondary area (depicted as small elliptical circles) known as TN cells, covering a TAI-3 and a TAI-4, which support a type-1 network service (e.g., S-NSSAI-1). In this first scenario 10, when the UE initiates a registration request for a specific slice service (e.g., S-NSSAI-1) that is not supported for the PLMN-1 while accessing a 5G system via the satellite-1, then the network declines the registration request based on a 5GMM cause: #62, indicating that the slice “S-NSSAI” is not available for the PLMN-1 in a 3rd Generation Partnership Project (3GPP) access. Although the same slice service “S-NSSAI-1” may be accessible for the same PLMN-1 in the NG-RAN access, the network's blockage for the PLMN in 3GPP access prevents the UE from attempting to access it via the NG-RAN node, as described in conjunction with FIG. 2. A similar scenario occurs vice versa, where if the UE faces rejection in the NG-RAN node, it is barred from accessing the same slice in the satellite-1 for the same PLMN-1, as described in conjunction with FIG. 3. In the existing telecommunication systems, when a UE is informed that “S-NSSAI(s) (e.g., S-NSSAI-1)” is unavailable in a current Public Land Mobile Network (PLMN) (e.g., PLMN-1 of FIG. 1A) or a Stand-Alone Non-Public Network (SNPN), the UE has a capability to store rejected S-NSSAI(s) in a rejected NSSAI list for the current PLMN or SNPN, as specified in subclause 4.6.2.2 of 3GPP TS 24.501. Subsequently, the UE refrains from attempting to utilize the S-NSSAI(s) in the current PLMN or SNPN until certain conditions are met, such as powering off the UE, removing a Universal Integrated Circuit Card (UICC) containing a Universal Subscriber Identity Module (USIM), updating an entry in a “list of subscriber data” with the SNPN identity of the current SNPN, or eliminating the rejected S-NSSAI(s) as specified in subclause 4.6.2.2 of 3GPP TS 24.501.

FIG. 2 is a sequence flow diagram illustrating a problem scenario associated with a network registration process for a PLMN in existing telecommunication systems, according to prior art. The sequence flow diagram described in reference to FIG. 1A may include several operations outlined as follows.

At operations 21-22, the UE attempts to camp on (e.g., establish connection and registration with) the NG-RAN satellite (the satellite 1 of FIG. 1A) of the PLMN-1 by transmitting an Radio Resource Control (RRC) connection setup complete message (registration request-initial) to access the S-NSSAI-1. Subsequently, at operation 23, the NG-RAN satellite forwards the received RRC connection setup complete message to a 5G-network (NW) (e.g., Access and Mobility Management Function (AMF)). At operation 24, upon reception of the RRC connection setup complete message, the 5G-NW detects that the S-NSSAI-1 is not supported by the NG-RAN satellite. At operation 25, upon detection, the 5G-NW sends a registration reject message along with an indication “#62: S-NSSAI is not available for the PLMN or SNPN” to the UE. At operations 26-27, the UE, upon reception of the registration reject message, re-selects or moves into coverage of to the NG-RAN of the PLMN-1 to access the S-NSSAI-1. However, due to the received indication, the UE is unable to access the S-NSSAI-1 even though the NG-RAN is capable of supporting it. This limitation represents a drawback of the existing telecommunication systems.

FIG. 3 is a sequence flow diagram illustrating another problem scenario associated with a network registration process for a PLMN in existing telecommunication systems, according to prior art. The sequence flow diagram described in reference to FIG. 1A may include several operations outlined as follows.

At operations 31-32, the UE attempts to camp on the NG-RAN of the PLMN-1 by transmitting an RRC connection setup complete message (registration request-initial) to access the S-NSSAI-1. Subsequently, at operation 33, the NG-RAN forwards the received RRC connection setup complete message to a 5G-network (NW) (e.g., AMF). At operation 34, upon reception of the RRC connection setup complete message, the 5G-NW detects that the S-NSSAI-1 is not supported by the NG-RAN. At operation 35, upon detection, the 5G-NW transmits a registration reject message along with an indication “#62: S-NSSAI is not available for the PLMN or SNPN” to the UE. At operations 36-37, the UE, upon reception of the registration reject message, reselects or moves into coverage of the NG-RAN satellite of the PLMN-1 to access the S-NSSAI-1. However, due to the received indication, the UE is unable to access the S-NSSAI-1even though the NG-RAN satellite is capable of supporting it. This limitation represents a drawback of the existing telecommunication systems.

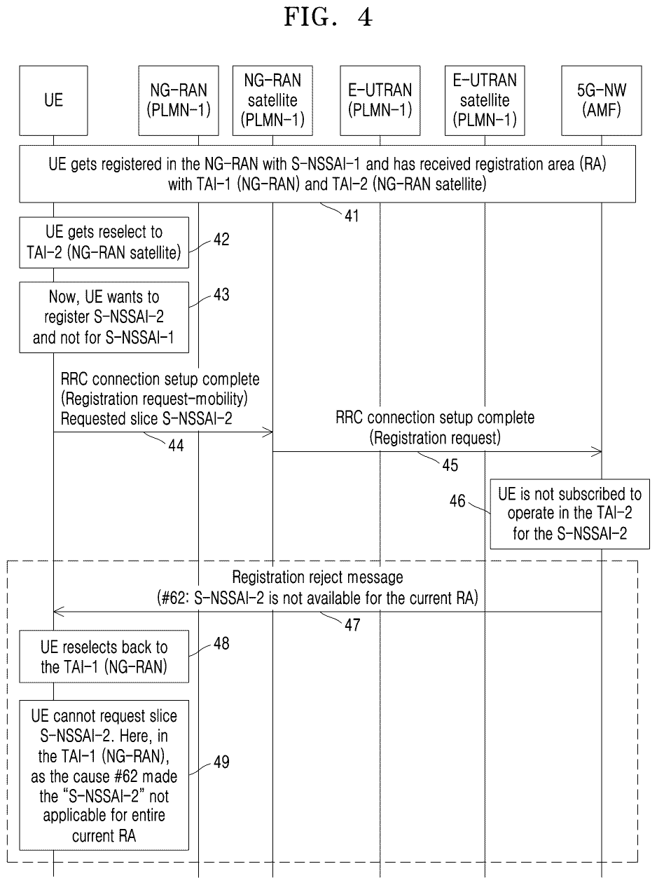

Now, consider a second scenario 11 of FIG. 1B, where all TAIs belong to a same Registration Area (RA) with the same architecture configuration as described above in the first scenario in reference to FIG. 1A. In the second scenario, when the UE initiates a registration request for a specific slice service (e.g., S-NSSAI-1) while accessing a 5G system via the NG-RAN satellite that is not supported for a current TAI (e.g., TAI-1 or TAI-2), then the network declines the registration request based on a 5GMM cause: #62, indicating that the slice “S-NSSAI” is not available for the current RA in 3GPP access. The same slice service/network service (e.g., S-NSSAI-1) could be available for the same PLMN in NG-RAN access in a different TAI of the RA, but since the network blocked it for the current RA in 3GPP access, the UE may not be able to attempt in the NG-RAN node(s), as described in conjunction with FIG. 4. A similar scenario occurs in vice versa. The UE getting reject in the NG-RAN nodes(s) gets blocked for accessing the same slice in the NG-RAN satellite in a different TAI of the current RA. In the existing telecommunication systems, when the UE is informed that “S-NSSAI(s) (e.g., S-NSSAI-1)” is unavailable in the current RA, the UE has the capability to store rejected S-NSSAI(s) in a rejected NSSAI list for the current RA, as specified in subclause 4.6.2.2 of 3GPP TS 24.501. Subsequently, the UE refrains from attempting to utilize the S-NSSAI(s) in the current RA until certain conditions are met, such as powering off the UE, removing the UICC containing the USIM, updating an entry in a “list of subscriber data” with the SNPN identity of the current SNPN, or eliminating the rejected S-NSSAI(s) as specified in subclause 4.6.2.2 of 3GPP TS 24.501. Herein, the RA may be one of a plurality of RAs included in a cellular or mobile network such as the PLMN-1.

FIG. 4 is a sequence flow diagram illustrating a problem scenario associated with a network registration process for an RA in existing telecommunication systems, according to prior art. The sequence flow diagram described in reference to FIG. 1B may include several operations outlined as follows.

At operation 41, the UE gets registered in the NG-RAN with S-NSSAI-1 and has received a registration area (RA) with a TAI-1 (NG-RAN) and a TAI-2 (NG-RAN satellite). At operation 42, the UE gets reselected to the TAI-2 (NG-RAN satellite). At operation 43, now the UE wants to register for the S-NSSAI-2 and not for the S-NSSAI-1. At operation 44, as a result of the operation 43, the UE transmits an RRC connection setup complete message (registration request-mobility) and requests for the slice “S-NSSAI-2” to the NG-RAN satellite. At operation 45, the NG-RAN satellite forwards the received message to the 5G-NW. At operation 46, the 5G-NW detects that “the UE is not subscribed to operate in the TAI-2 for the S-NSSAI-2”. At operation 47, as a result of the operation 46, the 5G-NW transmits a registration reject message along with an indication “#62: S-NSSAI is not available for the RA” to the UE. At operations 48-49, the UE, upon reception of the registration reject message, reselects or moves into coverage of TAI-1 (NG-RAN) to access the S-NSSAI-2. However, due to the received indication, the UE is unable to access the S-NSSAI-2 even though the NG-RAN of the TAI-1 is capable of supporting it. This limitation represents a drawback of the existing telecommunication systems. In other words, the UE moves to the TAI-1 NG-RAN even if the S-NSSAI-2 can be supported by the NG-RAN in the TAI-2, since the S-NSSAI-2 is mapped to not allow for the entire current RA, it cannot obtain service with that slice. The UE has to reselect to, for example, E-UTRAN or remain in NR without any service until moving out of the current RA even though service is possible in the NG-RAN for the S-NSSAI-2.

Additionally, in the existing telecommunication systems, deployment of PLMN identities, according to 3GPP TS 38.821, involves an assignment of distinct PLMN identities for NTN cells and TN cells, or across various types of NTN platforms (such as Geostationary Equatorial Orbit (GEO) or Low Earth Orbit (LEO)), which is deemed a favorable approach.

Nonetheless, the possibility of configuring common PLMN identities is not excluded. According to 3GPP TS 24.821, the PLMN identities can be identical for the NG-RAN node(s) and the NG-RAN satellite (GEO or LEO) based on the aforementioned descriptions. This ambiguity in the PLMN identities deployment may lead to complications or may result in challenges related to network management, resource allocation, handover procedures, and overall system efficiency. Inconsistencies or overlaps in PLMN identities can potentially lead to confusion, conflicts, and operational issues within the telecommunication infrastructure, impacting service delivery and user experience.

Moreover, in the existing telecommunication systems for RA management, according to 3GPP TS 23.501, the 5G system is mandated to facilitate the allocation of the RA by utilizing a single TAI List including tracking areas of any NG-RAN nodes within the RA for the UE. When constructing the TAI list, an Access and Mobility Management Function (AMF) is required to incorporate only TAIs that are relevant to the access type (i.e., 3GPP access or Non-3GPP access) to which the TAI list is directed. To mitigate excessive signaling overhead resulting from mobility registration update events triggered by every Radio Access Technology (RAT) change, it is advisable to refrain from generating an RAT-specific TAI list for a UE that supports multiple RATs. Improvement is necessary for slice management and selection within the RA where different TAI lists pertain to distinct RATs. Furthermore, in scenarios where a particular slice is unavailable in a specific RAT and PLMN combination, especially when that PLMN supports multiple NG RATs, it is imperative to provide the UE with appropriate indications for selecting the suitable RAT and PLMN combination for that slice within the same RA. This crucial functionality is currently lacking in the existing telecommunication systems.

Thus, it is desired to address the above-described disadvantages or other shortcomings or at least provide a useful alternative for performing a network registration process in a wireless network to access at least one network service.

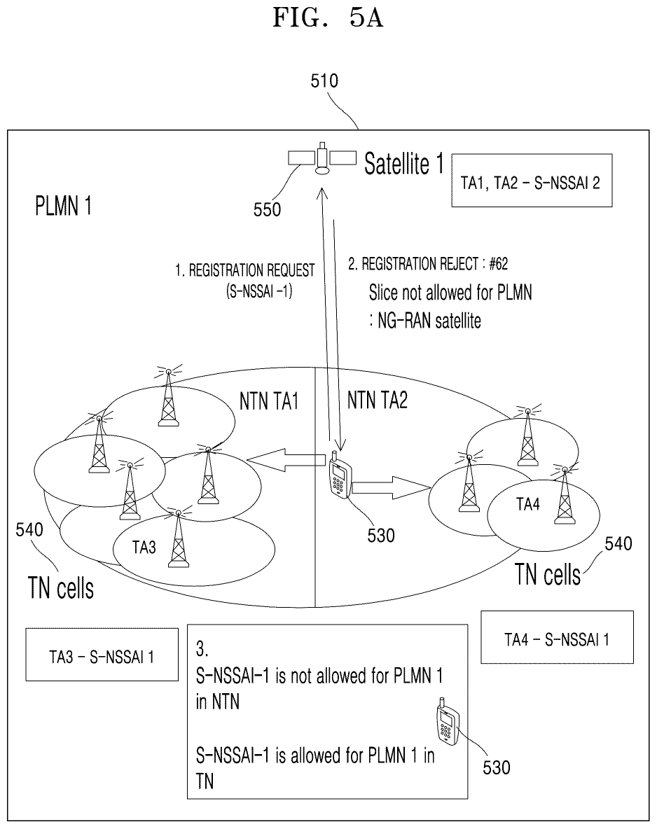

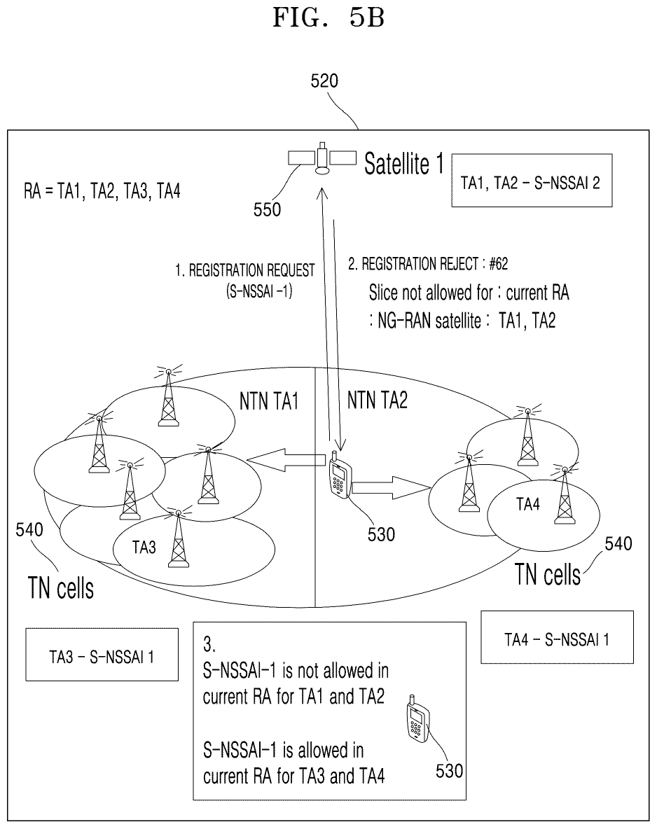

In one or more embodiments, both a network device (e.g., Next Generation Radio Access Network (NG-RAN), NG-RAN satellite, 5G-NW (Access and Mobility Management Function (AMF)), etc.) and a User Equipment (UE) consider an allowed Network Slice Selection Assistance Information (NSSAI) to be associated with finer granularity of access types within the 3^{rd} Generation Partnership Project (3GPP), where any of the following options are possible, which may relate to FIGS. 5A-5B to 10.
a. The allowed NSSAI is deemed to be linked with non-satellite 3GPP access Radio Access Technology (RAT) such as 3GPP Evolved Universal Terrestrial Radio Access (E-UTRA) (in NI mode) or New Radio (NR), when received through said RAT, and with satellite 3GPP access RAT when received via any form of satellite access RAT.
b. Alternatively, the allowed NSSAI is deemed to be linked with (i) non-satellite 3GPP access RAT such as the 3GPP E-UTRA (in NI mode) or the NR, when received via this RAT. (ii) a specific satellite access RAT (e.g., NR(GEO) or NR(LEO)) if received through that particular satellite access RAT. Therefore, in this scenario, the association of the allowed NSSAI with a specific RAT takes into account individual types of satellite RATs rather than just any form of satellite access, which could encompass any of the three possibilities. Optionally, the permissible NSSAI is considered to be associated with a specific group of satellite access RAT types, for example, NR (GEO) and NR (MEO) together, while another allowed NSSAI is associated with NR (LEO), provided that the NSSAI is received via these RATs. Consequently, in this option, at least one type of satellite access RAT can be deemed to be associated with the allowed NSSAI.
c. Alternatively, the network device discloses the RAT type to which the network slices are applicable: Upon receiving a registration accept message, the network device conveys slice information and, additionally, includes a new Information Element (IE) specifying the RAT in which the configured slices are permissible. This includes non-satellite 3GPP access RATs like 3GPP E-UTRA (in N1 mode) or NR if the communication occurred over such a RAT, or a specific satellite access RAT (e.g., NR (GEO) or NR (LEO)) if the communication was received through that particular satellite access RAT. Therefore, in this scenario, the linkage of the allowed Network NSSAI to a specific RAT takes into consideration individual satellite RAT types rather than encompassing all satellite access possibilities. Additionally, there is an option where the allowed NSSAI is associated with a specific group of satellite access RAT types, for instance, NR (GEO) and NR (MEO) combined, while another permissible NSSAI is linked with NR (LEO), provided that the NSSAI is received over these RATs. Consequently, in this case, at least one type of satellite access RAT can be deemed to be associated with the allowed NSSAI.

In one or more embodiments, the aforementioned options are also relevant to configured NSSAI, requested NSSAI, pending NSSAI, or rejected NSSAI, meaning that the requested or rejected NSSAI can be linked with different RAT types (or satellite vs. non-satellite access types) as detailed earlier.

In one or more embodiments, when a network device transmits, for example, a 5GMM cause: #62 “No network slice available” in a registration reject, service reject, deregistration request, or any Non Access Stratum (NAS) signaling message, the network device is required to include a new Information Element (IE) or update an extended rejected NSSAI IE to indicate the unsupported slice for a current Public Land Mobile Network (PLMN) in which an RAT of 3GPP access is operating.

In one or more embodiments, alternatively, AMF may convey to the UE a registration reject message with #62 “No network slice available” in the new IE or in the extended rejected NSSAI IE indicating the slice not supported for the current PLMN in which the RAT of 3GPP access is utilized, along with a satellite type (LEO, MEO, HEO, GEO, or any other satellite type).

In one or more embodiments, when the network device sends a 5GMM cause: #62 “No network slice available” in a registration reject, service reject, deregistration request, or any NAS signaling message, it must include the new IE or the extended rejected NSSAI IE indicating the unsupported slice for Tracking Area Identifiers (TAIs) in the current RAT by incorporating a list of rejected NSSAI TAIS.

In one or more embodiments, alternatively, when the network device transmits a 5GMM cause: #62 “No network slice available” in the registration reject, service reject, deregistration request, or any NAS signaling message without including any new IE, then the UE is expected to associate the rejected NSSAI for the current PLMN, current registration area (RA), or a current TAI solely for the RAT through which it received the 5GMM cause in 3GPP access.

In one or more embodiments, in a different scenario where the same PLMN identity is not configured for an NG-RAN, an NG-RAN satellite, and a satellite RAT type, distinct PLMN identities should be used for the NG-RAN, the NG-RAN satellite, and the satellite RAT type, and the registration area (RA) should encompass TAIs of a single RAT exclusively.

In one or more embodiments, the aforementioned embodiments/options/combinations are provided as examples and may not be viewed as limitations of the disclosure. These solutions may be implemented in any sequence or combination. Furthermore, these solutions may be applicable to various wireless networks such as 4G, 5G, 6G, and beyond.

Referring now to the drawings, and more particularly to FIGS. 5 to 10, where similar reference characters and numerals denote corresponding features consistently throughout the figures, various embodiments, which are example embodiments, are described herebelow.

FIGS. 5A and 5B illustrate one or more operations associated with a disclosed network registration process in a wireless network, according to one or more embodiments.

Consider a first scenario 510 in reference to FIG. 5A, where a satellite-1 550 (e.g., NG-RAN satellite) belonging to a PLMN-1 provides one or more network services to a UE 530 within a sizable coverage area (depicted as a large elliptical circle). The satellite-1 550 encompasses two tracking areas a TAI-1 and a TAI-2, and supports a type-2 network service (e.g., S-NSSAI-2). Furthermore, one or more base stations 540 (e.g., NG-RAN nodes associated with TN cells) belonging to the PLMN-1 provide the one or more network services to the UE 530 within a secondary area (depicted as small elliptical circles) known as TN cells, covering a TAI-3 and a TAI-4, which supports a type-1 network service (e.g., S-NSSAI-1).

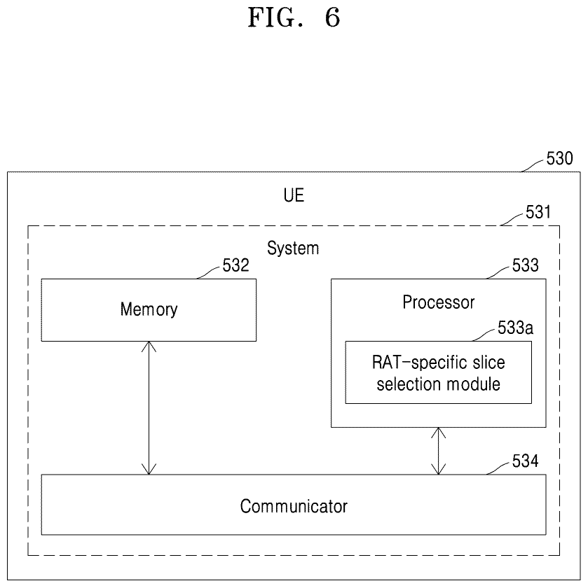

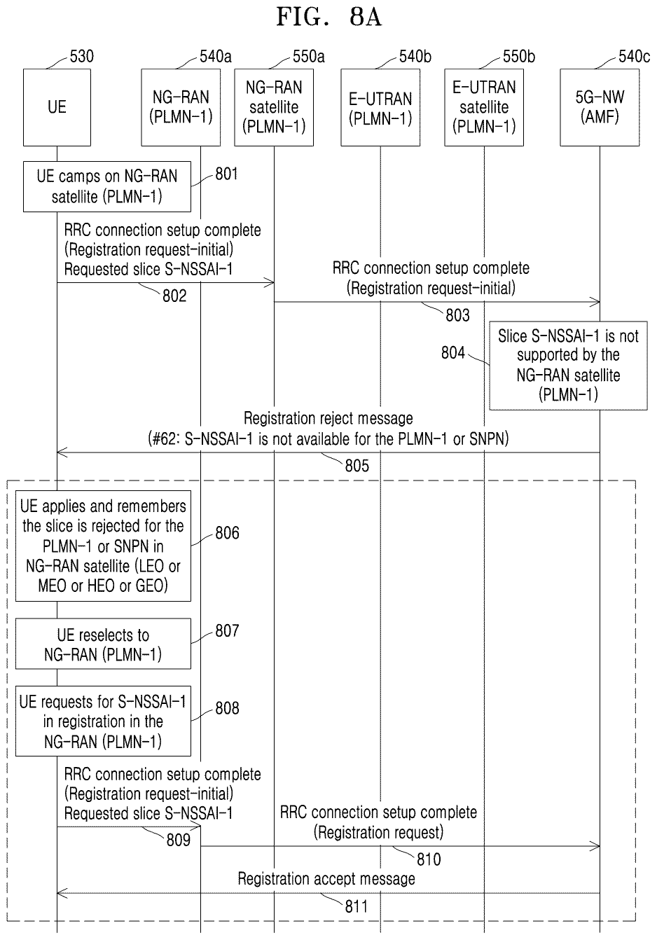

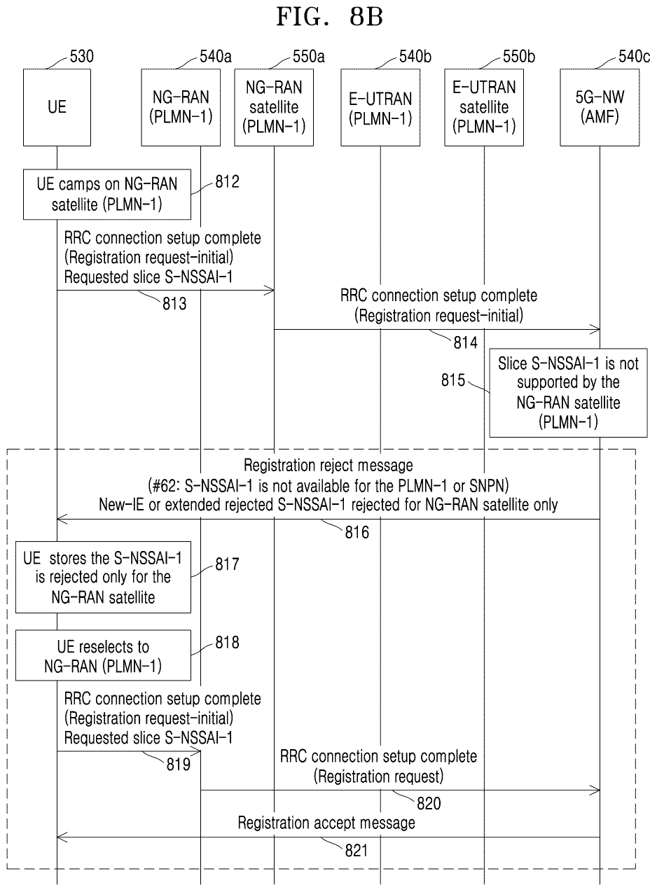

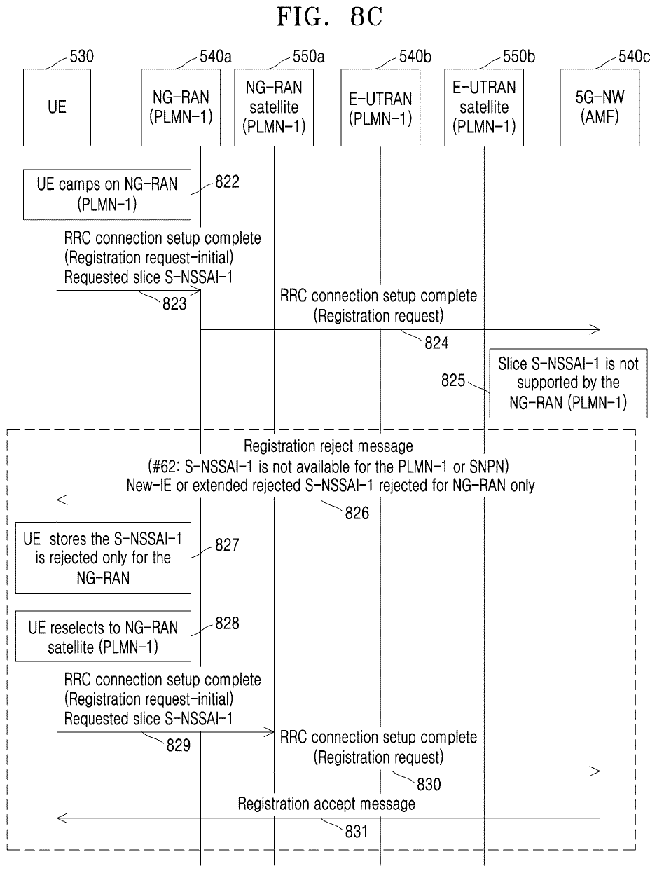

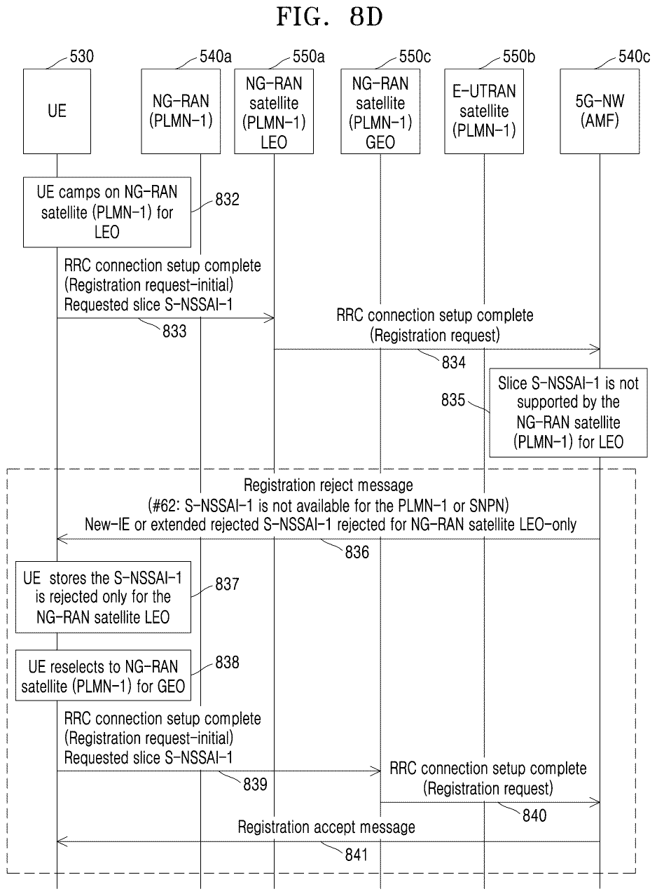

In this first scenario 510, when the UE initiates a registration request for a specific slice service (e.g., S-NSSAI-1) that is not supported for the PLMN-1 while accessing a 5G system via the NG-RAN satellite 550, then the network (e.g., AMF) declines the registration request based on a 5GMM cause: #62, indicating that the slice “S-NSSAI” is not available for the PLMN-1 along with indication which may include specific RAT information and/or additional information, as described in conjunction with FIGS. 6 and 8A-8D. For instance, the indication may include a message such as “N-NSSAI-1 is not allowed for the NG-RAN satellite 550 (NTN) and S-NSSAI-1 is allowed for one or more base stations 540 (e.g., NG-RAN nodes associated with TN cells) belonging to the same PLMN-1”. As a result, the UE may access the S-NSSAI-1 within the same PLMN-1 via the one or more base stations 540, showcasing an improvement over existing telecommunication systems as illustrated in FIGS. 1A and 1B.

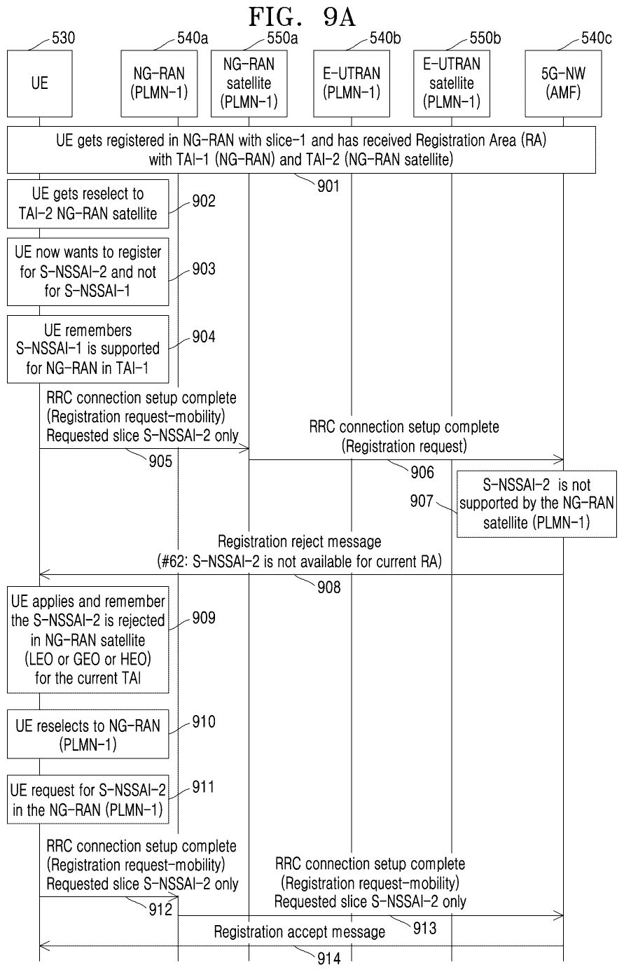

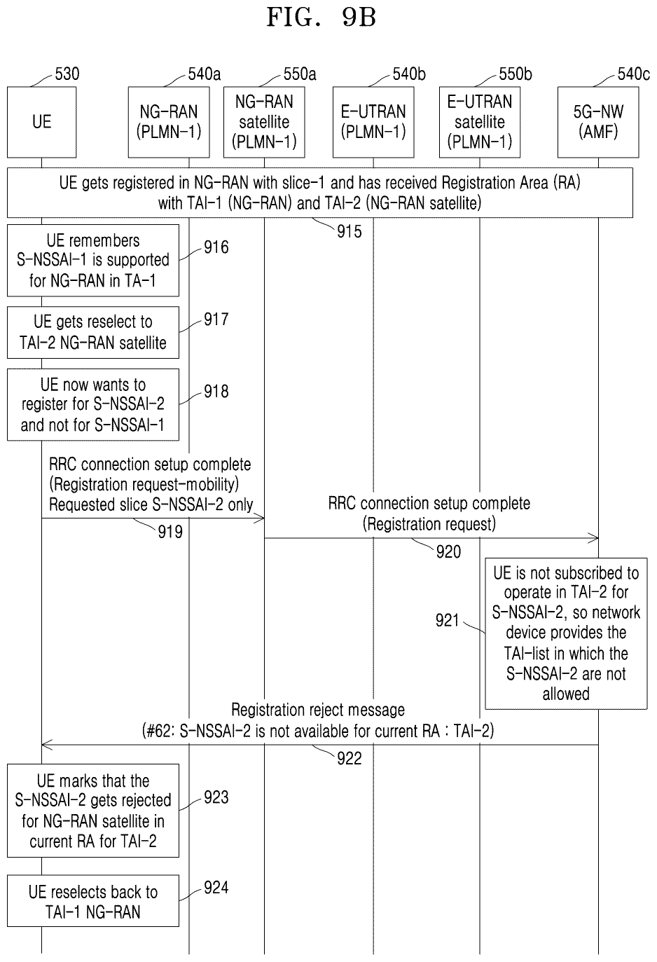

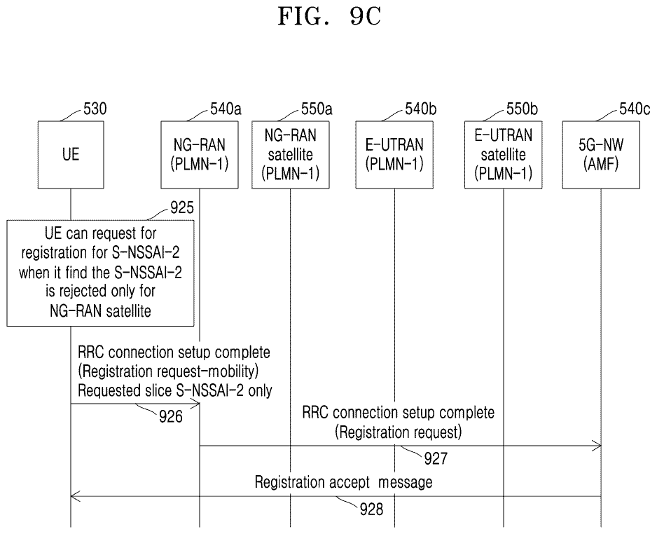

Now, consider a second scenario 520 in reference to FIG. 5B, where all TAIs belong to the same Registration Area (RA) with the same architecture configuration as described above in the first scenario 510. In the second scenario 520, when the UE 530 initiates a registration request for a specific slice service (e.g., S-NSSAI-1) that is not supported for a current TAI (e.g., TAI-1 or TAI-2) while accessing the 5G system via the NG-RAN satellite, then the network (e.g., AMF (not shown)) declines the registration request based on a 5GMM cause: #62, indicating that the slice “S-NSSAI-1” is not available for the PLMN-1 along with indication which may include specific RAT information and/or additional information, as described in conjunction with FIG. 6 and FIG. 9A-9C. For instance, the indication may include a message such as “S-NSSAI-1 is not allowed for current RA for TAI-1 and TAI-2, and S-NSSAI-1 is allowed for TAI-3 and TAI-4” belonging to the same RA. As a result, the UE may access the S-NSSAI-1 within the same RA via the one or more base stations 540, showcasing an improvement over existing telecommunication systems as illustrated in FIGS. 1A and 1B.

FIG. 6 illustrates a block diagram of the UE 530 for performing the network registration process in the wireless network to access at least one network service, according to one or more embodiments. Examples of the UE 530 may include, but are not limited to, a smartphone, a tablet computer, a personal digital assistance (PDA), an Internet of Things (IOT) device, and a wearable device. Examples of the wireless networks may include, but are not limited to, Non-Terrestrial Networks (NTN) and Terrestrial Networks (TN). Examples of the at least one network service may include, but are not limited to, an Enhanced Mobile Broadband (eMBB) slice service, an Ultra-Reliable Low Latency Communication (URLLC) slice service, and a Massive Machine Type Communication (MMTC) slice service, a Vehicle-to-everything (V2x) slice service, a High Performance Machine Type Communication (HMTC) slice service.

In one or more embodiments, the UE 530 may include a system 531. The system 531 may include a memory 532, a processor 533, and a communicator 534. In one or more embodiments, the system 531 may be implemented on one or multiple electronic devices (not shown in FIG).

In one or more embodiments, the memory 532 may store computer instructions to be executed by the processor 533 for performing the network registration process in the wireless network to access the at least one network service, as discussed throughout the disclosure. The memory 532 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 532 may, in some examples, be considered a non-transitory storage medium. The term “non-transitory” may indicate that the storage medium is not embodied in a carrier wave or a propagated signal. However, the term “non-transitory” should not be interpreted that the memory 532 is non-movable. In some examples, the memory 532 can be configured to store larger amounts of information. In certain examples, a non-transitory storage medium may store data that can, over time, change (e.g., in Random Access Memory (RAM) or cache). The memory 532 can be an internal storage unit, or it can be an external storage unit of the electronic device 530, a cloud storage, or any other type of external storage.

The processor 533 communicates with the memory 532 and the communicator 534. The processor 533 is configured to execute instructions stored in the memory 532 and to perform various processes for performing the network registration process in the wireless network to access the at least one network service, as discussed throughout the disclosure. The processor 533 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In one or more embodiments, the processor 533 may include an RAT-specific slice selection module 533a. The RAT-specific slice selection module 533a may be implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the RAT-specific slice selection module 533a may execute multiple operations to perform the network registration process in the wireless network to access the at least one network service, which are given below.

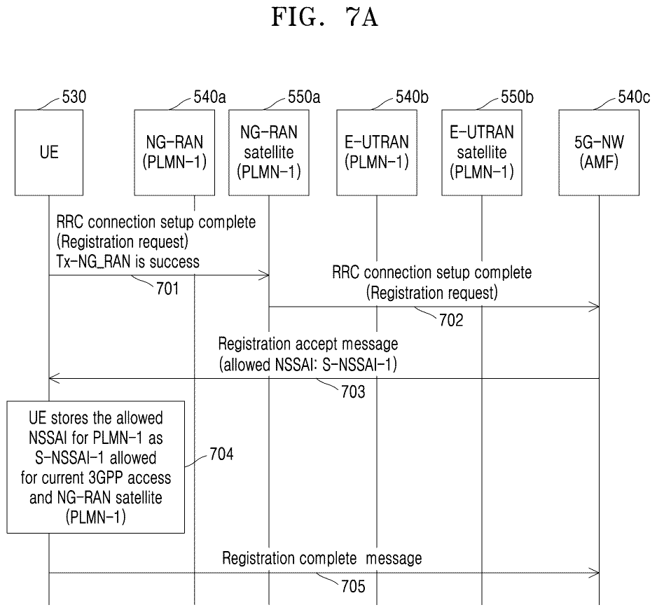

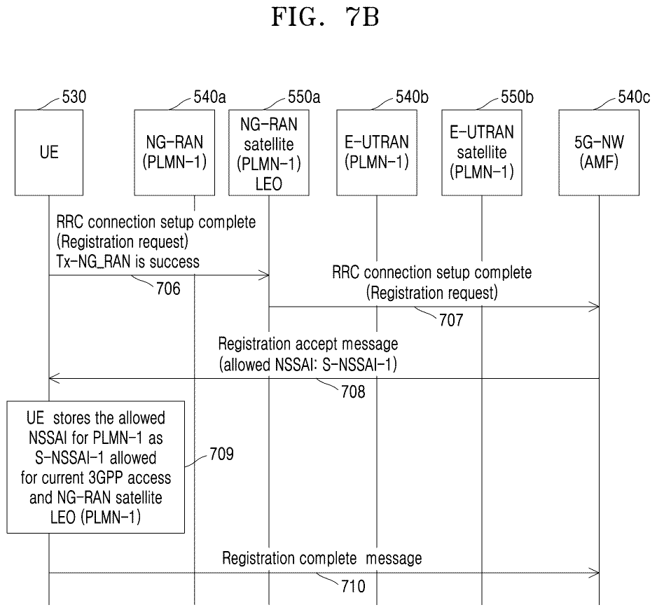

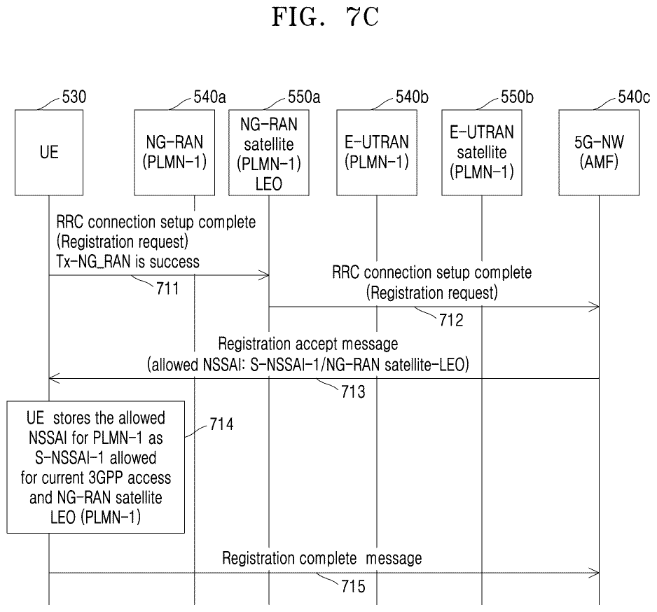

In one or more embodiments, the RAT-specific slice selection module 533a may transmit a network registration request to the network device (e.g., the base station 540, the satellite-1 550, etc.) of the wireless network to access one or more S-NSSAI, wherein both the UE 530 and the network device are associated with the same PLMN-1. The RAT-specific slice selection module 533a may receive a network registration response message including one of a registration accept message or a registration reject message. The RAT-specific slice selection module 533a may camp based on the received response message, by the UE 530, on one of the network device or another network device within the wireless network sharing the same PLMN-1 to access the one or more requested S-NSSAI(s), as described in conjunction with FIGS. 7A-7C, FIGS. 8A-8D, and FIGS. 9A-9C.

In one or more embodiments, the RAT-specific slice selection module 533a may determine whether the received network registration response includes one of the registration accept message and the registration reject message. The RAT-specific slice selection module 533a may camp on the network device when the network device is capable of supporting the one or more requested S-NSSAI(s) and provide access to the UE 530 in response to determining that the received network registration response including the registration accept message. The RAT-specific slice selection module 533a may camp on the another network device when the network device is not capable of supporting the one or more requested S-NSSAI(s) and does not provide access to the UE 530 in response to determining that the received network registration response includes the registration reject message.

In one or more embodiments, the RAT-specific slice selection module 533a may determine, upon reception of the registration reject message, whether additional information associated with the network device is present in the registration reject message. In one or more embodiments, the additional information may be received from the network device. In one or more embodiments, the additional information may indicate a lack of support for the one or more requested S-NSSAI(s) by the network device. In one or more embodiments, the additional information may be provided in a new Information Element (IE) or an existing extended reject NSSAI IE with a Radio Access Technology (RAT) type may be updated to indicate the lack of support for the one or more requested S-NSSAI(s) by the network device. In one or more embodiments, the additional information may be provided in the new IE or updated in the existing extended reject NSSAI IE to indicate the lack of support for the one or more requested S-NSSAI(s) by the network device. The RAT-specific slice selection module 533a may further store the additional information associated with the network in a list in response to determining that the additional information associated with the network device is present in the registration reject message. The RAT-specific slice selection module 533a may further map information associated with the lack of support for the one or more requested S-NSSAI(s) with a corresponding network device in response to determining that the additional information associated with the network device is not present in the registration reject message, wherein the mapping information is stored in the list. The RAT-specific slice selection module 533a may further utilize the stored information or the list to camp on the another network device within the wireless network sharing the same PLMN to access the one or more requested S-NSSAI.

In one or more embodiments, the additional information may be provided in one or more network messages including at least one of the registration reject message, a service reject message, a deregistration request message, and any Non-Access Stratum (NAS) signaling message.

In one or more embodiments, the additional information may include a cause code (e.g., #62) that indicates the one or more requested S-NSSAI(s) are not supported by the network device.

In one or more embodiments, the RAT type may refer, for example, but is not limited to, a Next Generation Radio Access Network (NG-RAN) or a satellite Next Generation Radio Access Network (NG-RAN satellite) which includes at least one of Low Earth Orbit (LEO), Medium Earth Orbit (MEO), Highly Elliptical Orbit (HEO), Geostationary Orbit (GEO), and a maritime connection satellite.

In one or more embodiments, the RAT-specific slice selection module 533a may map the one or more S-NSSAI(s) to a Radio Access Technology (RAT) type, wherein the one or more S-NSSAI(s) includes one of an allowed NSSAI, partially allowed NSSAI, a rejected NSSAI, a partially rejected NSSAI, a pending NSSAI, and a configured NSSAI(s). The RAT-specific slice selection module 533a may further store information associated with the mapping in the UE 530.

In one or more embodiments, the RAT-specific slice selection module 533a may configure each network device and each RAT with a unique PLMN identity to maintain proper network functionality and avoid potential conflicts or issues between each of the network devices.

In one or more embodiments, the RAT-specific slice selection module 533a may disable an N1 mode specific to a particular PLMN and Radio Access Technology (RAT) where the UE is camped, triggered by a NAS reject message due to unavailability of services for the one or more requested S-NSSAI(s) in that particular RAT.

In one or more embodiments, the RAT-specific slice selection module 533a may transmit the network registration request to the network device of the wireless network to access the one or more S-NSSAI(s), wherein both the UE and the network device are associated with the same Registration Area (RA), wherein the network device includes a first set of Tracking Area Identities (TAIs). The RAT-specific slice selection module 533a may further receive upon sending the network registration request, the network registration response message including one of the registration accept message or the registration reject message, along with additional information associated with the one or more requested S-NSSAI(s). The RAT-specific slice selection module 533a may further camp, based on the received response message, on one of the network device or another network device within the wireless network sharing the same RA to access the one or more requested S-NSSAI(s), wherein the another network device includes a second set of TAIs.

In one or more embodiments, the RAT-specific slice selection module 533a may determine, upon receiving the registration reject message, whether additional information associated with the network device is present in the registration reject message. In one or more embodiments, the additional information may indicate the lack of support for the one or more requested S-NSSAI(s) by the network device with the first set of TAIs. In one or more embodiments, the additional information may be provided in a new Information Element (IE) or an existing extended reject NSSAI IE with a Radio Access Technology (RAT) type may be updated to indicate the lack of support for the one or more requested S-NSSAI(s) by the network device with the first set of TAIs. In one or more embodiments, the additional information may be provided in the new IE or updated in the existing extended reject NSSAI IE indicating the lack of support for the one or more requested S-NSSAI(s) by the network device with the first set of TAIs. The RAT-specific slice selection module 533a may further store the additional information associated with the network device in a list in response to determining that the additional information associated with the network device is present in the registration reject message. The RAT-specific slice selection module 533a may further mapping information associated with the lack of support for the one or more requested S-NSSAI(s) with a corresponding network device with the first set of TAIs in response to determining that the additional information associated with the network device is not present in the registration reject message, wherein the mapping information is stored in the list. The RAT-specific slice selection module 533a may further utilize the stored information or the list to camp on the another network device, associated with the second set of TAIs, within the wireless network sharing the same RA to access the one or more requested S-NSSAI.

In one or more embodiments, the RA may exclusively consist of TAIs associated with a single Radio Access Technology (RAT).

In one or more embodiments, the RAT-specific slice selection module 533a may select, upon receiving the registration reject message, the same or different RAT on a different PLMN and select it if a combination is not present in the stored list.

The communicator 534 is configured for communicating internally between internal hardware components and with external devices (e.g., server, NG-RAN node, NG-RAN satellite, AMF, etc.) via one or more networks (e.g., radio technology). The communicator 534 may include an electronic circuit specific to a standard that enables wired or wireless communication.

Although FIG. 6 shows various hardware components of the UE 530, but it is to be understood that the disclosure is not limited thereto. In one or more other embodiments, the UE 530 may include less or more number of components. Further, the labels or names of the components are used only for illustrative purposes and do not limit the scope of the disclosure. One or more components can be combined to perform the same or substantially similar functions to perform the network registration process in the wireless network to access the at least one network service.

FIGS. 7A-7C are sequence diagrams illustrating various operations associated with the network registration process when the UE 530 receives the registration accept message from the network device, according to one or more embodiments. The network device may include one or more NTN nodes and/or one or more TN nodes. For example, an NG-RAN (PLMN-1) 540a, an E-UTRAN (PLMN-1) 540b, a 5G-NW 540c an NG-RAN satellite (PLMN-1) 550a, and an E-UTRAN satellite (PLMN-1) 550b. The sequence flow diagrams may include several operations outlined as follows.

Referring to FIG. 7A: at operation 701, the UE 530 attempts to camp on the NG-RAN satellite 550a of the PLMN-1 by transmitting an RRC connection setup complete message (registration request), for example, to access the S-NSSAI-1. Subsequently, at operation 702, the NG-RAN satellite 550a of the PLMN-1 forwards the received RRC connection setup complete message to the 5G-network (NW) 540c (e.g., AMF). At operation 703, upon reception of the RRC connection setup complete message, the 5G-NW 540c detects that the S-NSSAI-1 is supported by the NG-RAN satellite 550a of the PLMN-1. Upon detection, the 5G-NW 540c sends a registration accept message with the indication as “allowed NSSAI: S-NSSAI-1”. At operation 704, upon reception of the registration accept message, the UE 530 stores the allowed NSSAI for PLMN-1 as S-NSSAI-1 allowed for the current 3GPP access and the NG-RAN satellite 550a (PLMN-1). In other words, the UE 530 maps itself to the current RAT, for example, “allowed NSSAI: S-NSSAI-1 supported by the NG-RAN satellite 550a of the PLMN-1”. At operation 705, upon storage, the UE 530 transmits a registration complete message to the 5G-NW 540c.

Referring to FIG. 7B: at operation 706, the UE 530 attempts to camp on the NG-RAN satellite 550a of the PLMN-1, wherein a satellite type is an LEO, by transmitting the RRC connection setup complete message (registration request), for example, to access the S-NSSAI-1. Subsequently, at operation 707, the NG-RAN satellite 550a of the PLMN-1 forwards the received RRC connection setup complete message to the 5G-NW 540c (e.g., AMF). At operation 708, upon reception of the RRC connection setup complete message, the 5G-NW 540c detects that the S-NSSAI-1 is supported by the NG-RAN satellite 550a of the PLMN-1. Upon detection, the 5G-NW 540c sends the registration accept message with the indication as “allowed NSSAI: S-NSSAI-1”. At operation 709, upon reception of the registration accept message, the UE 530 stores the allowed NSSAI for PLMN-1 as the S-NSSAI-1 allowed for current 3GPP access and the NG-RAN satellite LEO (PLMN-1). In other words, the UE 530 maps itself to the current RAT with a satellite type, for example, “allowed NSSAI: S-NSSAI-1 supported by the NG-RAN satellite 550a of the PLMN-1, with the satellite type as the LEO”. At operation 710, upon storage, the UE 530 transmits the registration complete message to the 5G-NW 540c.

Referring to FIG. 7C: at operation 711, the UE 530 attempts to camp on the NG-RAN satellite 550a of the PLMN-1, wherein the satellite type is the LEO, by transmitting the RRC connection setup complete message (registration request), for example, to access the S-NSSAI-1. Subsequently, at operation 712, the NG-RAN satellite 550a of the PLMN-1 forwards the received RRC connection setup complete message to the 5G-NW 540c (e.g., AMF). At operation 713, upon reception of the RRC connection setup complete message, the 5G-NW detects that the S-NSSAI-1 is supported by the NG-RAN satellite 550a of the PLMN-1. Upon detection, the 5G-NW 540c sends the registration accept message with the indication as “allowed NSSAI: S-NSSAI-1/NG-RAN satellite-LEO”. At operation 714, upon reception of the registration accept message, the UE 530 stores the allowed NSSAI for PLMN-1 as S-NSSAI-1 allowed for the current 3GPP access and the NG-RAN satellite LEO (PLMN-1). In other words, the 5G-NW 540c provides the RAT type for which the allowed NSSAI is allowed. As a result, the UE 530 does not map itself to the current RAT with a satellite type.

FIGS. 8A-8D are sequence diagrams illustrating various operations associated with the network registration process when the UE 530 receives the registration reject message from the network device in the same PLMN, according to one or more embodiments. The sequence flow diagrams may include several operations outlined as follows.

Referring to FIG. 8A: at operations 801-802, the UE 530 attempts to camp on the NG-RAN satellite 550a of the PLMN-1 by transmitting the RRC connection setup complete message (registration request-initial) to access the S-NSSAI-1. Subsequently, at operation 803, the NG-RAN satellite 550a of the PLMN-1 forwards the received RRC connection setup complete message to the 5G-NW 540c (e.g., AMF). At operation 804, upon reception of the RRC connection setup complete message, the 5G-NW 540c detects that the S-NSSAI-1 is not supported by the NG-RAN satellite of the PLMN-1 550a. At operation 805, upon detection, the 5G-NW 540c sends the registration reject message along with an indication “#62: S-NSSAI is not available for the PLMN or SNPN” to the UE 530. At operation 806, the UE 530, upon reception of the registration reject message, the UE 530 applies and remembers the service slice is rejected for the PLMN-1 or SNPN in the NG-RAN satellite 550a of the PLMN-1 (LEO or MEO or HEO or GEO). At operation 807, the UE 530 reselects or moves into coverage of the NG-RAN 540a of the PLMN-1 to access the S-NSSAI-1. The NG-RAN 540a may include a base station or an NG-RAN node. At operations 808-809, the UE 530 requests to the NG-RAN 540a of the PLMN-1 by transmitting the RRC connection setup complete message (registration request-initial) to access the S-NSSAI-1. Subsequently, at operation 810, the NG-RAN 540a of the PLMN-1 forwards the received RRC connection setup complete message to the 5G-NW 540c. At operation 811, the UE 530 receives the registration accept message from the 5G-NW 540c.

In other words, FIG. 8A illustrates a “UE-based solution” wherein the UE 530 performs one or more operations (e.g., 806, 807, 808, etc.) to access the S-NSSAI-1 via another network device of the same PLMN. This occurs when the UE 530 identifies the absence of additional information with/in the registration reject message. For instance, the UE 530 may access the S-NSSAI-1 within the same PLMN (i.e., PLMN-1) via the NG-RAN 540a of the PLMN-1, showcasing an improvement over the existing telecommunication systems.

Referring to FIG. 8B: at operations 812-813, the UE 530 attempts to camp on the NG-RAN satellite 550a of the PLMN-1 by transmitting the RRC connection setup complete message (registration request-initial) to access the S-NSSAI-1. Subsequently, at operation 814, the NG-RAN satellite 550a of the PLMN-1 forwards the received RRC connection setup complete message to the 5G-NW 540c (e.g., AMF). At operation 815, upon reception of the RRC connection setup complete message, the 5G-NW 540c detects that the S-NSSAI-1 is not supported by the NG-RAN satellite of the PLMN-1 550a. At operation 816, upon detection, the 5G-NW 540c sends the registration reject message along with an indication “#62: S-NSSAI is not available for the PLMN or SNPN” along with the additional information as “New-IE or extended rejected S-NSSAI-1 rejected for NG-RAN satellite only” to the UE 530. At operation 817, the UE 530, upon reception of the registration reject message, the UE 530 stores the additional information such as “the S-NSSAI-1 is rejected only for the NG-RAN satellite”. At operation 818, the UE 530 reselects or moves into coverage of the NG-RAN 540a of the PLMN-1to access the S-NSSAI-1. At operation 819, the UE 530 requests to the NG-RAN 540a of the PLMN-1 by transmitting the RRC connection setup complete message (registration request-initial) to access the S-NSSAI-1. Subsequently, at operation 820, the NG-RAN 540a of the PLMN-1 forwards the received RRC connection setup complete message to the 5G-NW 540c. At operation 821, the UE 530 receives the registration accept message from the 5G-NW 540c.

In other words, FIG. 8B illustrates “NW provides that slice is rejected only for NG-RAN satellite”, wherein the UE 530 performs, by utilizing the additional information, one or more operations (e.g., 817, 818, etc.) to access the S-NSSAI-1 via another network device of the same PLMN. This occurs when the UE 530 identifies the presence of additional information with/in the registration reject message, wherein the additional information is shared by the 5G-NW 540c. For instance, the UE 530 may access the S-NSSAI-1 within the same PLMN (i.e., PLMN-1) via the NG-RAN 540a of the PLMN-1, showcasing an improvement over the existing telecommunication systems.

Referring to FIG. 8C: at operations 822-823, the UE 530 attempts to camp on the NG-RAN 540a of the PLMN-1 by transmitting the RRC connection setup complete message (registration request-initial) to access the S-NSSAI-1. Subsequently, at operation 824, the NG-RAN 540a of the PLMN-1 forwards the received RRC connection setup complete message to the 5G-NW 540c (e.g., AMF). At operation 825, upon reception of the RRC connection setup complete message, the 5G-NW 540c detects that the S-NSSAI-1 is not supported by the NG-RAN 540a of the PLMN-1. At operation 826, upon detection, the 5G-NW 540c sends the registration reject message along with an indication “#62: S-NSSAI is not available for the PLMN or SNPN” along with the additional information as “New-IE or extended rejected S-NSSAI-1 rejected for NG-RAN only” to the UE 530. At operation 827, the UE 530, upon reception of the registration reject message, the UE 530 stores the additional information such as “the S-NSSAI-1 is rejected only for the NG-RAN”. At operation 828, the UE 530 reselects or moves into coverage of the NG-RAN satellite 550a of the PLMN-1 to access the S-NSSAI-1. At operation 829, the UE 530 requests to the NG-RAN satellite 550a of the PLMN-1 by transmitting the RRC connection setup complete message (registration request-initial) to access the S-NSSAI-1. Subsequently, at operation 830, the NG-RAN satellite 550a of the PLMN-1 forwards the received RRC connection setup complete message to the 5G-NW 540c. At operation 831, the UE 530 receives the registration accept message from the 5G-NW 540c.

In other words, FIG. 8C illustrates “NW provides that slice is rejected only for NG-RAN”, wherein the UE 530 performs, by utilizing the additional information, one or more operations (e.g., 827, 828, etc.) to access the S-NSSAI-1 via another network device of the same PLMN. This occurs when the UE 530 identifies the presence of additional information with/in the registration reject message, wherein the additional information is shared by the 5G-NW 540c. For instance, the UE 530 may access the S-NSSAI-1 within the same PLMN (i.e., PLMN-1) via the NG-RAN satellite 550a of the PLMN-1, showcasing an improvement over the existing telecommunication systems.

Referring to FIG. 8D: at operations 832-833, the UE 530 attempts to camp on the NG-RAN satellite of the PLMN-1 (LEO) 550a by transmitting the RRC connection setup complete message (registration request-initial) to access the S-NSSAI-1. Subsequently, at operation 834, the NG-RAN satellite (LEO) 550a of the PLMN-1 forwards the received RRC connection setup complete message to the 5G-NW 540c (e.g., AMF). At operation 835, upon reception of the RRC connection setup complete message, the 5G-NW 540c detects that the S-NSSAI-1 is not supported by the NG-RAN satellite (LEO) 550a of the PLMN-1. At operation 836, upon detection, the 5G-NW 540c sends the registration reject message along with an indication “#62: S-NSSAI is not available for the PLMN or SNPN” along with the additional information as “New-IE or extended rejected S-NSSAI-1 rejected for NG-RAN satellite (LEO) only” to the UE 530. At operation 837, the UE 530, upon reception of the registration reject message, the UE 530 stores the additional information such as “the S-NSSAI-1 is rejected only for the NG-RAN satellite (LEO)”. At operation 838, the UE 530 reselects or moves into coverage of the NG-RAN (GEO) 550c of the PLMN-1 to access the S-NSSAI-1. At operation 839, the UE 530 requests to the NG-RAN (GEO) 550c of the PLMN-1 by transmitting the RRC connection setup complete message (registration request-initial) to access the S-NSSAI-1. Subsequently, at operation 840, the NG-RAN (GEO) 550c of the PLMN-1 forwards the received RRC connection setup complete message to the 5G-NW 540c. At operation 841, the UE 530 receives the registration accept message from the 5G-NW 540c.

In other words, FIG. 8D illustrates “NW provides that slice is rejected only for NG-RAN satellite (LEO)”, wherein the UE 530 performs, by utilizing the additional information, one or more operations (e.g., 837, 838, etc.) to access the S-NSSAI-1 via another network device of the same PLMN. This occurs when the UE 530 identifies the presence of additional information with/in the registration reject message, wherein the additional information is shared by the 5G-NW 540c. For instance, the UE 530 may access the S-NSSAI-1 within the same PLMN (i.e., PLMN-1) via the NG-RAN satellite (GEO) 550c of the PLMN-1, showcasing an improvement over the existing telecommunication systems.

FIGS. 9A-9C are sequence diagrams illustrating various operations associated with the network registration process when the UE 530 receives the registration reject message from the network device in the same RA, according to one or more embodiments. The sequence flow diagrams may include several operations outlined as follows.

Referring to FIG. 9A: at operation 901, the UE 530 gets registered in the NG-RAN with S-NSSAI-1 and has received a registration area (RA) with a TAI-1 (NG-RAN 540a) and a TAI-2 (NG-RAN satellite 550a). At operation 902, the UE 530 gets reselected to the TAI-2 (NG-RAN satellite 550a). At operation 903, now the UE 530 wants to register for the S-NSSAI-2 and not for the S-NSSAI-1. At operation 904, the UE 530 remembers the S-NSSAI-1 is supported for the NG-RAN 540a in TAI-1. At operation 905, the UE 530 transmits the RRC connection setup complete message (registration request-mobility) and requests for the slice “S-NSSAI-2” to the NG-RAN satellite 550a. At operation 906, the NG-RAN satellite 550a forwards the received message to the 5G-NW 540c. At operation 907, the 5G-NW 540c detects that “S-NSSAI-2 is not supported by the NG-RAN satellite”. At operation 908, as a result of the operation 907, the 5G-NW 540c transmits the registration reject message along with an indication “#62: S-NSSAI-2 is not available for the RA” to the UE 530.

At operation 909, the UE 530 applies and remember the S-NSSAI-2 is rejected in the NG-RAN satellite 550a (LEO or GEO or HEO) for the current TAI. At operation 910, the UE 530 reselects to the NG-RAN 540a of the PLMN-1. At operation 911, the UE 530 request for the S-NSSAI-2 in the NG-RAN of the PLMN-1 540a. At operation 912, the UE 530 transmits the RRC connection setup complete (registration request-mobility) for the S-NSSAI-2. At operation 913, the NG-RAN of the PLMN-1 540a forwards the received RRC connection setup complete (registration request-mobility) for the S-NSSAI-2 to the 5G-NW 540c. At operation 914, the UE 530 receives the registration accept message from the 5G-NW 540c.

In other words, FIG. 9A illustrates a “UE-based solution”, wherein the UE 530 performs one or more operations (e.g., 909, 910, 911, etc.) to access the S-NSSAI-2 via another network device in the same RA. This occurs when the UE 530 identifies the absence of additional information with/in the registration reject message. For instance, the UE 530 may access the S-NSSAI-2 in the same RA via the NG-RAN 540a of the PLMN-1, showcasing an improvement over the existing telecommunication systems.

Referring to FIGS. 9B-9C: at operation 915, the UE 530 gets registered in the NG-RAN with S-NSSAI-1 and has received the registration area (RA) with the TAI-1 (NG-RAN 540a) and the TAI-2 (NG-RAN satellite 550a). At operation 916, the UE 530 remembers the S-NSSAI-1 is supported for the NG-RAN in TAI-1. At operation 917, the UE 530 gets reselected to the TAI-2 (NG-RAN satellite 550a). At operation 918, now the UE 530 wants to register for the S-NSSAI-2 and not for the S-NSSAI-1. At operation 919, the UE 530 transmits the RRC connection setup complete message (registration request-mobility) and requests for the slice “S-NSSAI-2″ to the NG-RAN satellite 550a. At operation 920, the NG-RAN satellite 550a forwards the received message to the 5G-NW 540c. At operation 921, the 5G-NW 540c detects that UE 530 is not subscribed to operate in the TAI-2 for S-NSSAI-2, so the 5G-NW 540c provides the TAI-list in which the S-NSSAI-2 is not allowed. At operation 922, the 5G-NW 540c transmits the registration reject message along with an indication ”#62: S-NSSAI-2 is not available for the RA: TAI-2″ to the UE 530.

At operation 923, the UE 530 marks that the S-NSSAI-2 gets rejected for the NG-RAN satellite 550a in the current RA for the TAI-2. At operation 924, the UE 530 reselects or moves into coverage of the TAI-1 NG-RAN 540a. At operation 925, the UE 530 can request for registration for the S-NSSAI-2 when it finds that the S-NSSAI-2 is rejected only for the NG-RAN satellite 550a. At operation 926, the UE 530 transmits the RRC connection setup complete (registration request-mobility) for the S-NSSAI-2 to the NG-RAN 540a of the PLMN-1. At operation 927, the NG-RAN 540a of the PLMN-1 forwards the received RRC connection setup complete (registration request-mobility) for the S-NSSAI-2 to the 5G-NW 540c. At operation 928, the UE 530 receives the registration accept message from the 5G-NW 540c.

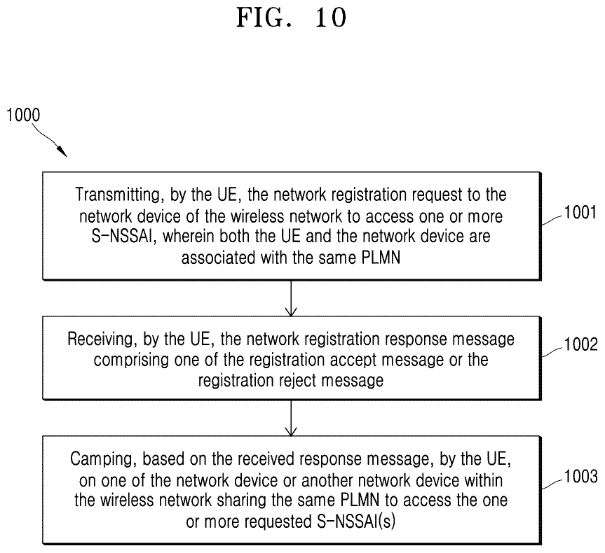

FIG. 10 is a flow diagram illustrating a method 1000 for performing a network registration process in a wireless network to access at least one network service, according to one or more embodiments.

At step 1001, the method 1000 includes transmitting a network registration request to a network device of a wireless network to access a one or more S-NSSAI, wherein both a UE and the network device are associated with a same PLMN. At step 1002, the method 1000 includes receiving a network registration response message including one of a registration accept message and a registration reject message. At step 1003, the method 1000 includes camping, based on the received response message, on one of the network device and another network device within the wireless network sharing the same PLMN to access the one or more requested S-NSSAI(s).

Further, a detailed description related to the various steps of FIG. 10 is covered in the description related to FIGS. 7A-7C to FIGS. 9A-9C, and is omitted herein for the sake of brevity.

In the above-described embodiments, the UE (e.g., the UE 530) is described as attempting to access only network slices or network slice services corresponding to or indicated by the S-NSSAI-1 and the S-NSSAI-2. However, the disclosure is not limited thereto, and, the embodiments also apply to the UE attempting to access different network slices or network slice services.

The various actions, acts, blocks, steps, or the like in the flow/sequence diagrams may be performed in the order presented, in a different order, or simultaneously. Further, in some embodiments, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the disclosure as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the embodiments will so fully reveal the general nature of the embodiments herein that others can, by applying current knowledge, readily modify and/or adapt for various applications such embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described, those skilled in the art will recognize that the embodiments herein can be practiced with modification within the scope of the embodiments as described herein.

1. A method for performing network registration in a wireless network to access at least one network service, the method comprising:
transmitting, by a user Equipment (UE), a network registration request to a network device of the wireless network to access one or more network slice services, wherein both the UE and the network device are associated with a same public land mobile network (PLMN);
receiving, by the UE, a response message comprising one of a registration accept message and a registration reject message; and
registering, based on the response message, by the UE, with one of the network device and another network device within the wireless network sharing the same PLMN to access the one or more network slice services.

2. The method as claimed in claim 1, wherein the registering, based on the response message, with one of the network device or another network device comprises:
determining whether the response message comprises one of the registration accept message and the registration reject message; and
performing one of:
registering with the network device based on the network device being capable of supporting the one or more network slice services, and providing access to the UE in response to determining that the response message comprising the registration accept message; or
registering with the other network device based on the network device not being capable of supporting the one or more network slice services, and not providing access to the UE in response to determining that the response message comprises the registration reject message.

3. The method as claimed in claim 1, comprising:
determining, upon receiving the registration reject message, whether additional information associated with the network device is present in the registration reject message;
storing the additional information associated with the network device in a list in response to determining that the additional information associated with the network device is present in the registration reject message, wherein the additional information is received from the network device to indicate a lack of support for the one or more network slice services by the network device, wherein the additional information is provided in a new information element (IE) or an existing IE with a radio access technology (RAT) type is updated to indicate the lack of support for the one or more network slice services by the network device, and wherein the additional information comprises a cause code indicating that the one or more network slice services are not supported by the network device;
mapping information associated with the lack of support for the one or more network slice services with a corresponding network device in response to determining that the additional information associated with the network device is not present in the registration reject message, wherein the mapped information is stored in the list; and
utilizing the mapped information or the list to register with the other network device within the wireless network sharing the same PLMN to access the one or more network slice services.

4. The method as claimed in claim 3, wherein the additional information is provided in one or more network messages comprising at least one of the registration reject message, a service reject message, a deregistration request message, and any non-access stratum (NAS) signaling message.

5. The method as claimed in claim 1, comprising:
determining, upon receiving the registration reject message, whether the UE is able to find the same PLMN in one of another radio access technology (RAT) and a different combination of RAT and tracking area identity (TAI) in a same registration area;
selecting another PLMN in a same RAT in response to determining that the UE is not able to find the same PLMN in one of the other RAT or the different combination of RAT and TAI in the same registration area.

6. The method as claimed in claim 3, wherein the RAT type comprises a Next Generation Radio Access Network (NG-RAN) or a satellite Next Generation Radio Access Network (NG-RAN satellite) comprising at least one of Low Earth Orbit (LEO), Medium Earth Orbit (MEO), Highly Elliptical Orbit (HEO), Geostationary Orbit (GEO), and a maritime connection satellite.

7. The method as claimed in claim 1, comprising:
transmitting, by the UE, the network registration request to the network device of the wireless network to access the one or more network slice services, wherein both the UE and the network device are associated with a same registration area, wherein the network device comprises a first set of tracking area identities(TAIs);
receiving, upon sending the network registration request, the response message comprising one of the registration accept message and the registration reject message, along with additional information associated with the one or more network slice services; and
registering, based on the response message, with one of the network device or another network device within the wireless network sharing a same registration area to access the one or more network slice services, wherein the other network device comprises a second set of TAIs.

8. The method as claimed in claim 7, comprising:
determining, upon receiving the registration reject message, whether additional information associated with the network device is present in the registration reject message;
storing the additional information associated with the network device in a list in response to determining that the additional information associated with the network device is present in the registration reject message, wherein the additional information is received from the network device, wherein the additional information indicates a lack of support for the one or more network slice services by the network device with the first set of TAIs, and wherein the additional information is provided in a new information element (IE) or an existing IE with a radio access technology (RAT) type is updated to indicate the lack of support for the one or more network slice services by the network device with the first set of TAIS, ;
mapping information associated with the lack of support for the one or more network slice services with a corresponding network device with the first set of TAIs in response to determining that the additional information associated with the network device is not present in the registration reject message, wherein the mapped information is stored in the list; and
utilizing the additional information or the list to register with the other network device, associated with the second set of TAIs, within the wireless network sharing the same registration area to access the one or more network slice services.

9. The method as claimed in claim 7 wherein the registration area exclusively consists of TAIs associated with a single RAT.

10. A User Equipment (UE) comprising:
a memory;
a communicator; and
a processor operably connected to the memory and the communicator,
wherein the processor is configured to:
transmit a network registration request to a network device of a wireless network to access one or more network slice services, wherein both the UE and the network device are associated with a same public land mobile network (PLMN);
receive a response message comprising one of a registration accept message and a registration reject message; and
register, based on the response message, by the UE, on one of the network device and another network device within the wireless network sharing the same PLMN to access the one or more network slice services.

11. The UE as claimed in claim 10, wherein the processor is configured to:
determine whether the response message comprises one of the registration accept message and the registration reject message; and
perform one of:
registering with the network device based on the network device being capable of supporting the one or more network slice services and providing access to the UE in response to determining that the response message comprising the registration accept message; or
registering with the other network device based on the network device not being capable of supporting the one or more network slice services and not providing access to the UE in response to determining that the response message comprises the registration reject message.

12. The UE as claimed in claim 10, wherein the processor is configured to:
determine, upon receiving the registration reject message, whether additional information associated with the network device is present in the registration reject message;
store the additional information associated with the network in a list in response to determining that the additional information associated with the network device is present in the registration reject message, wherein the additional information is received from the network device, wherein the additional information indicates a lack of support for the one or more network slice services by the network device, wherein the additional information is provided in a new information element (IE) or an existing IE with a radio access technology (RAT) type is updated to indicate the lack of support for the one or more network slice services by the network device wherein the additional information is provided in one or more network messages comprising the registration reject message, a service reject message, a deregistration request message, and any non-access stratum (NAS) signaling message, wherein the additional information comprises a cause code that indicates the one or more network slice services is not supported by the network device, and wherein the RAT type comprises a Next Generation Radio Access Network (NG-RAN) or a satellite Next Generation Radio Access Network (NG-RAN satellite) comprising at least one of Low Earth Orbit (LEO), Medium Earth Orbit (MEO), Highly Elliptical Orbit (HEO), Geostationary Orbit (GEO), and a maritime connection satellite;
mapping information associated with the lack of support for the one or more network slice services with a corresponding network device in response to determining that the additional information associated with the network device is not present in the registration reject message, wherein the mapped information is stored in the list; and
utilizing the additional information or the list to register the other network device within the wireless network sharing the same PLMN to access the one or more network slice services.

13. The UE as claimed in claim 10, wherein the processor is configured to:
map the one or more network slice services to a radio access technology (RAT) type, wherein the one or more network slice services comprises one of an allowed network slice services, a partially allowed network slice services, a rejected network slice service, a partially rejected network slice services, a pending network slice service, and a configured network slice service; and
store the mapped information in the UE.

14. The UE as claimed in claim 10, wherein the processor is configured to:
configure each network device and each RAT with a unique PLMN identity to maintain proper network functionality and avoid potential conflicts or issues between each of the network devices.

15. The UE as claimed in claim 10, wherein the processor is configured to:
disable a UE connection mode specific to a particular PLMN and a particular radio access technology (RAT) where the UE is registered, triggered by a non-access stratum (NAS) reject message due to unavailability of services for the one or more network slice services in the particular RAT.

16. The UE as claimed in claim 10, wherein the processor is configured to:
transmit the network registration request to the network device of the wireless network to access the one or more network slice services, wherein both the UE and the network device are associated with a same registration area, and wherein the network device comprises a first set of tracking area identities (TAIs);
receive, upon sending the network registration request, the response message comprising one of the registration accept message and the registration reject message, along with additional information associated with the one or more network slice services; and
register, based on the response message, with one of the network device or another network device within the wireless network sharing a same registration area to access the one or more network slice services, wherein the other network device comprises a second set of TAIs.

17. The UE as claimed in claim 16, wherein the processor is configured to:
determine, upon receiving the registration reject message, whether additional information associated with the network device is present in the registration reject message;
store the additional information associated with the network device in a list in response to determining that the additional information associated with the network device is present in the registration reject message, wherein the additional information is received from the network device, wherein the additional information indicates a lack of support for the one or more network slice services by the network device with the first set of TAIs, wherein the additional information is provided in a new IE or an existing IE with a radio access technology (RAT) type indicating the lack of support for the one or more network slice services by the network device with the first set of TAIs, and wherein the registration area exclusively consists of TAIS associated with a single RAT;
map information associated with the lack of support for the one or more network slice services with a corresponding network device with the first set of TAIs in response to determining that the additional information associated with the network device is not present in the registration reject message, wherein the mapped information is stored in the list; and
utilize the additional information or the list to register with the other network device, associated with the second set of TAIs, within the wireless network sharing the same registration area to access the one or more network slice services.

18. A User Equipment (UE) comprising:
a memory;
a communicator; and
a processor operably connected to the memory and the communicator,
wherein the processor is configured to:
transmit a network registration request to a network device of the wireless network to access one or more network slice services, wherein both the UE and the network device are associated with a same registration area comprising a plurality of tracking area identities (TAIs);
receive a response message comprising one of a registration accept message and a registration reject message; and
register, based on the response message, by the UE, with one of the network device and another network device within the wireless network sharing the same registration area to access the one or more network slice services.

19. The UE of claim 18, wherein the response message comprises the registration reject message which comprises information about TAIs in which the one or more network slice services are not allowed for the UE.

20. The UE of claim 19, wherein, based on the registration reject message, the processor is configured to register the other network device to access the one or more network slice services.
